(19) United States
(12) Patent Application Publication
(10) Pub. No.: US 2011/0012728 A1
(43) Pub. Date: Jan. 20, 2011

(54) Sensor and System to Detect Bridge Scour

(75) Inventors: Kirsten McCane, Hanover, MD (US); Peter J. Hawrylak, Woodstown, NJ (US); Marlin H. Mickle, Pittsburgh, PA (US)

Correspondence Address: ECKERT SEAMANS CHERIN & MELLOTT, 600 GRANT STREET, 44TH FLOOR, PITTSBURGH, PA, 15219, US

(73) Assignee: University of Pittsburgh-Of the Commonwealth System of Higher Education, Pittsburgh, PA (US)

(21) Appl. No.: 12/826,835

(22) Filed: Jun. 30, 2010

Related U.S. Application Data
(60) Provisional application No. 61/221,681, filed on Jun. 30, 2009.

(51) Int. Cl. G08B 1/08; G01C 9/06

(52) U.S. Cl. 340/539.1; 33/366.12

(57) ABSTRACT

A system for detecting scour associated with a structure having a part thereof extending into a bed of material located under a body of water is provided. The system comprises a sensor unit buried in a portion of the bed of material located in proximity to the part. The sensor unit is structured to float to a surface of the body of water and automatically wirelessly transmit a message after being released from the bed of material in response to at least some of the portion of the bed of material being scoured. The system also comprises a receiver unit structured to wirelessly receive the message.

### CROSS-REFERENCE TO RELATED APPLICATION

This application claims priority under 35 U.S.C. §119(e) from U.S. Provisional Application No. 61/221,681, entitled “Sensor/System to Detect Bridge Scour”, which was filed on Jun. 30, 2009, the disclosure of which is incorporated herein by reference.

### FIELD OF THE INVENTION

The present invention is directed to sensing devices and systems, and more particularly, to devices and systems for detecting bridge scour.

### BACKGROUND OF THE INVENTION

Bridge scour is a severe problem that costs millions of dollars in terms of damage, loss of life, and required annual maintenance by leaving infrastructure, including bridge piers and docks, in unsafe conditions. Scouring events commonly occur during times of rapid river flow and icing conditions when sediment, including soil, rocks, gravel, silt, and/or other filler materials used to help support structures located generally over, through or near water, such as bridges or dams, is transported by water currents away from piers and similar structures. If the scour event is severe enough, foundation material below the support structure may be eroded, leaving the structure unsupported and in jeopardy of collapse. Scour is dynamic, and ablation and deposition can occur simultaneously so the net effect cannot be easily predicted. Measurement of scour is therefore useful in monitoring stability and repair needs for bridges and other waterway structures before major damage occurs.

Currently, there are several techniques and devices used for detecting and monitoring scour, including subsurface interface radar, transducers, optical fathometers, physical probes, and visual inspection. All of these devices suffer from significant drawbacks.

Radar has been successfully employed to bathymetrically determine scour conditions. The technique is usually used after an event, indicating the final status of the sedimentation surrounding a pier. Sonar techniques have been similarly employed. Neither of these techniques is continuously employed in situ during a scour event and both require skilled operators to perform the test and interpret the results.

Neutral buoyancy “fish” equipped with a seismic transducer and a radio transmitter have been tethered at varying depths in the sediments around bridge piers (Zabilansky, L. J., Ice Force and Scour Instrumentation for the White River, Cold Regions Research and Engineering Laboratory, Hanover, N.H., Special Report 96-6, April 1996). As the fish are uncovered by the scouring process their sensing elements are moved by the currents and their transmitted signals are detected by a receiver located on the shore, that indicate that the scour has reached their tethered depth. During a depositional event, the fish are re-buried at approximately their original depth. While this system can be reset, it still provides a fairly crude water velocity measurement correlated to a spatial indication of the scour progression with a limited operational life due to the continuous transmission of signals from the fish. Additionally, transmission through water is most difficult and generally requiring wires for secure alerts.

Various devices are known in the patented prior art for detecting and monitoring scouring. For example, U.S. Pat. No. 4,855,966 to Cinquino, discloses a method and apparatus for monitoring bridge structures for scouring having apparatus for determining the distance between the topmost portion of the soil bed and one or more fixed points on a pier. In one embodiment of the invention, the distance determining apparatus comprises a sonar device for sonically determining the distance between the soil bed and a fixed point on the pier. Such device is generally expensive and requires complicated measurements.

U.S. Pat. No. 3,617,996 to Herbert, discloses an apparatus for scour detection at bridge piers and the like utilizing a plurality of electroacoustical transducers mounted on the structure to measure the effects of scouring on the soil bed adjacent to the structure. Such system generally requires complicated measurements.

Scouring measurement and detection utilizing time domain reflectometry (TDR) has been suggested. Such technology is generally complicated and requires a transmission line cable to be hard wired from submerged sensors to a remotely located TDR measurement instrument. The cable is generally the weak link in the implementation. Significant labor and special structural means are required to install this cable and the cable remains vulnerable to being disturbed or destroyed by the effects of scour. Also, the cable can easily be tangled during a flooding/scouring event. The method of measurement is also highly complicated

The present invention was developed in order to overcome these and other drawbacks of the prior devices.

### SUMMARY OF THE INVENTION

In one non-limiting embodiment, the invention provides a system for detecting scour associated with a structure having a part thereof extending into a bed of material located under a body of water. The system comprises a sensor unit buried in a portion of the bed of material located in proximity to the part. The sensor unit is structured to float to a surface of the body of water and automatically wirelessly transmit a message containing a precise location of a scour event level after being released from the bed of material in response to at least some of the portion of the bed of material being scoured. The system also comprises a receiver unit structured to wirelessly receive the message.

The sensor unit may include one or more switches structured to cause the sensor unit to automatically wirelessly transmit the message based on an orientation of the sensor unit.

The sensor unit may be in a first orientation when buried in a portion of the bed of material. When in the first orientation, the one or more switches do not enable the sensor unit to automatically wirelessly transmit the message. The sensor unit may be in a second orientation when floating on the surface of the body of water. When in the second orientation, the one or more switches may cause the sensor unit to automatically wirelessly transmit the message. The message may identify the sensor unit and consequently the scour location.

The system may comprise a display device operatively coupled to the receiver unit and structured to generate a particular output based on the message. The display device may comprise a light indicator and the particular output may comprise a particular light output.

In another non-limiting embodiment, the invention provides a system for detecting scour associated with a structure having a part thereof extending into a bed of material located under or partially under a body of water. The system comprises a plurality of sensor units, each of the sensor units being buried in an associated portion of the bed of material located in proximity to the part. Each of the sensor units is structured to float to a surface of the body of water and automatically wirelessly transmit a message identifying the sensor unit after being released from the bed of material in response to at least some of the portion of the bed of material associated with the sensor unit being scoured. The system also comprises a receiver unit structured to wirelessly receive each of the messages.

Each associated portion of the bed of material may be located at a different depth within the bed of material. Each associated portion of the bed of material may be located at a different location within the bed of material.

Each of the sensor units may include one or more switches structured to cause the sensor unit to automatically wirelessly transmit the associated message based on an orientation of the sensor unit. Each respective sensor unit of the plurality of sensor units may be in a first orientation when buried in a portion of the bed of material. When in the first orientation, the one or more switches do not enable the respective sensor unit to automatically wirelessly transmit the message. Each respective sensor unit may be in a second orientation when floating on the surface of the body of water. When in the second orientation, the one or more switches cause the respective sensor unit to automatically wirelessly transmit the message.

The system may further comprise a display device operatively coupled to the receiver unit and structured to generate a particular output based each message that is received. The display device may comprise a light indicator, and the particular output may comprise a particular light output.

In yet another non-limiting embodiment, the invention provides a system for detecting an occurrence of an event. The system comprises a sensor unit provided at a particular three dimensional location, the sensor unit comprising one or more switches structured to cause the sensor unit to automatically wirelessly transmit a message based on an orientation of the sensor unit. The sensor unit is in a first orientation when provided at the particular location prior to the occurrence of the event. When in the first orientation the one or more switches do not enable the sensor unit to automatically wirelessly transmit the message. The sensor unit is in a second orientation following the occurrence of the event. When in the second orientation the one or more switches cause the sensor unit to automatically wirelessly transmit the message. The system also comprises a receiver unit structured to wirelessly receive the message.

The event may be a movement of material at the particular location, wherein the sensor unit is buried within the material in the first orientation prior to the occurrence of the event. The event may be flooding of a body of water at the particular location and the sensor unit may be provided adjacent to the body of water at the particular location in the first orientation prior to the occurrence of the event.

In yet a further non-limiting embodiment, the invention provides a sensor unit for detecting scour associated with a structure having a part thereof extending into a bed of material located under a body of water. The sensor unit comprises a housing structured to be buried in a portion of the bed of material located in proximity to the part. The housing being buoyant and structured to float to a surface of the body of water after being released from the bed of material in response to at least some of the portion of the bed of material being scoured. The sensor unit also comprises a system disposed in the housing, the system being structured to wirelessly transmit a message after the housing is released from the bed of material.

The system may comprise a transmitter and one or more switches structured to cause the transmitter to automatically wirelessly transmit the message based on an orientation of the housing.

The housing may be in a first orientation when buried in a portion of the bed of material. When in the first orientation, the one or more switches do not enable the sensor unit to automatically wirelessly transmit the message. The housing unit may be in a second orientation when floating on the surface of or passing through the body of water. When in the second orientation, the one or more switches may cause the sensor unit to automatically wirelessly transmit the message. The message may identify the sensor unit.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a schematic depiction of a system for detecting scour in accordance with a non-limiting embodiment of the present invention; and

FIG. 2 is a schematic depiction of a sensor unit for detecting scour in accordance with a non-limiting embodiment of the present invention.

### DESCRIPTION OF THE PREFERRED EMBODIMENTS

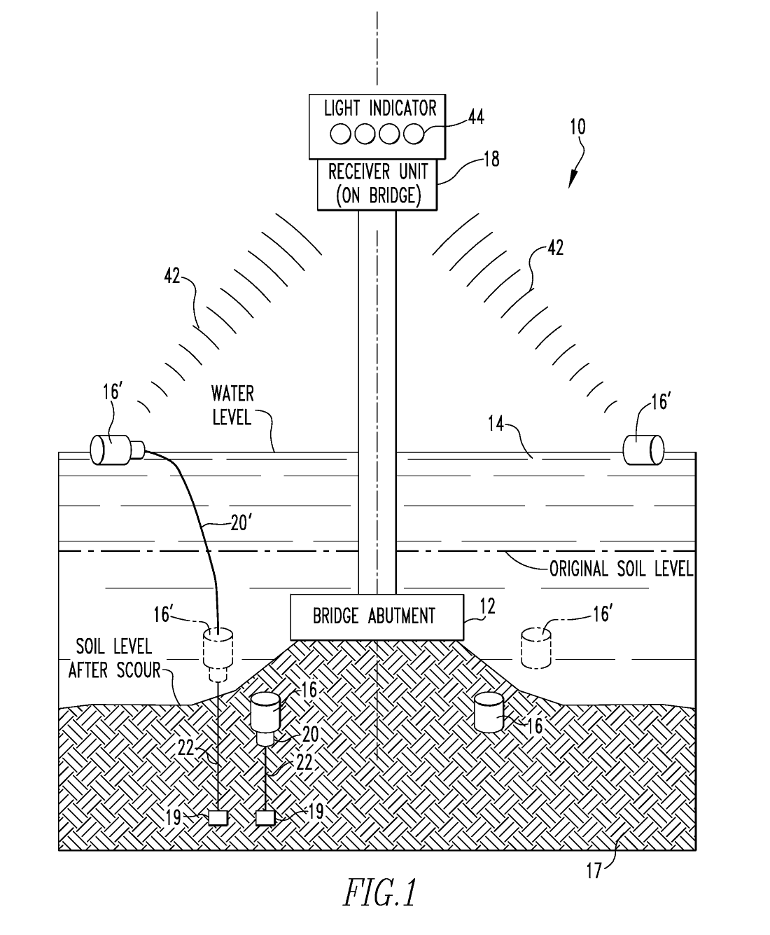

Referring to FIG. 1, a schematic depiction of a non-limiting embodiment of a system 10 according to the present invention for detecting scour near a support element, such as bridge abutment 12 located in a body of water 14 is shown. The support element may, for example, without limitation, be a portion of a bridge, dam, or any other structure located over, through or near a body of water or other similar application where scour or similar process is of potential concern. The system 10 includes a number of sensor units 16 that are initially buried among material 17 (e.g., without limitation, soil, rocks, gravel, silt, and/or other filler materials) at a location generally at or near a portion of the bridge abutment 12. As employed herein, the term “number” shall mean one or an integer greater than one (i.e., a plurality). The system further includes one or more receiver units 18 generally mounted on the bridge or on or near the bridge abutment 12. Each receiver unit 18 is adapted to receive signals from one or more of the sensor units 16.

Each sensor unit 16 may be buried during initial construction of the bridge abutment 12 or may be buried at a later time as desired. The general size and shape of each of the sensor units 16, as discussed in greater detail below, generally provides for such retrofitting to existing structures to be commonly carried out through the use of a hollow stem/core auger or other suitable device. As will be discussed in greater detail below, each sensor unit is initially buried in an inactive (powered down) state and becomes active (powered up) once reoriented from the initial position as a result of being unburied due to scour. Preferably, such initial position is a generally vertical position, in contrast to a horizontal floating position.

Each sensor unit 16 is generally sufficiently buoyant such that when unburied, due to scour, will simply float to the surface of the water 14. Sensor units 16′ of FIG. 1 generally show how a sensor will go from a buried position (shown in hidden line) to a floating position (shown in solid line) when the original soil level is scoured away to a new scour level below the original location of the buried sensor units 16′.

As shown generally on the right side of FIG. 1, each of the sensor units 16 may be buried without any other associated elements (i.e., each unit is simply buried at a desired location). Alternatively, such as shown generally on the left side of FIG. 1, each of the sensor units 16 may have additional elements associated therewith, such as an anchor member 19 and tether 20 which generally couples one or more sensor units 16 to an anchor member 19. Tether 20 may be in the form of an initially coiled wire (or other suitable structure) that extends by uncoiling when the sensor unit 16 to which the tether 20 is coupled becomes unburied due to scour and floats toward the surface of water 14. A pole or other suitable member 22 may be used in conjunction with anchor member 19 in installations in which the anchor member 19 is placed a distance from the desired burial location of coupled sensor unit 16. Such tether 20 is generally of sufficient length to allow the coupled sensor unit 16 to float to the surface of water 14 while generally keeping the sensor unit 16 from floating too far from the bridge abutment 12. An example of such an extended tether is shown by tether 20′ coupled to floating sensor unit 16′ on the left side of FIG. 1. It is to be appreciated that a sensor unit 16, as described herein, may be produced at a sufficiently low cost that such unit may be sacrificial, thus eliminating any tethers and potential accompanying problems (e.g., tangled tethers).

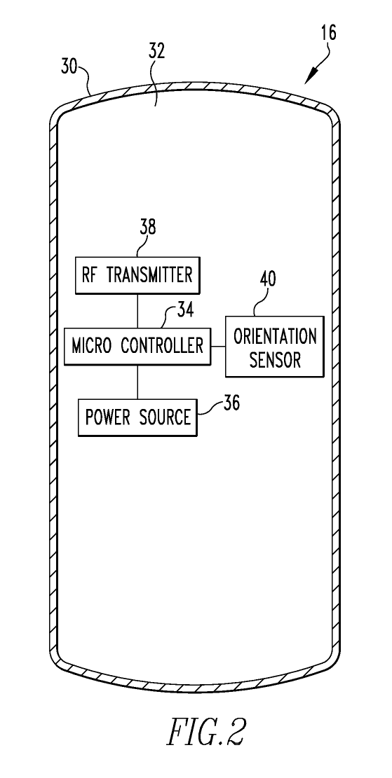

FIG. 2 shows a schematic depiction of a sensor unit 16 in accordance with a non-limiting embodiment of the present invention. As previously discussed, sensor unit 16 is generally buoyant and in one embodiment includes a generally cylindrical housing 30 defining a watertight space 32 therein. Continuing to refer to FIG. 2, sensor unit 16 further includes a microcontroller 34 electrically coupled to a power source 36 (e.g., without limitation, batteries), an RF transmitter 38, and an orientation sensor 40. Microcontroller 34 preferably contains a memory with information regarding the particular sensor unit 16 stored therein (e.g., without limitation, structure to which disposed adjacent, position, depth, etc.). Orientation sensor 40 may comprise one or more mercury switches or other suitable devices capable of detecting a change in the orientation of the housing 30. For example, without limitation, such orientation change may be from a generally vertical position to a generally horizontal position, or vice-versa. As shown in FIG. 1, when in use, sensor unit 16 is buried in a first orientation (shown as a cylinder extending generally vertically) that is different than the second orientation the unit would assume once unburied and floating (shown as a cylinder extending generally horizontally). To ensure the desired floating orientation is obtained, one or more weights (not shown) may be associated with the sensor unit 16 (e.g., without limitation, supplied internal, external, or integrated with housing 30).

When initially buried in such first orientation, the components contained within housing 30 are preferably in a powered down or nearly powered down state in order to conserve power source 36. When the orientation of housing 30 changes from the vertical (as shown in this example) due to becoming unburied and thus free to float in a horizontal position, the components contained within housing 30 power up and become active. Such activation of the components is triggered by orientation sensor 40 (or a combination of orientation sensors) detecting the change in orientation, thus allowing the components to power-up. It is to be appreciated that as the sensor unit 16 is preferably totally passive until reoriented, the only limitation on the lifetime of the sensor unit 16 is the normal shelf life of the power source 36 itself.

Once powered-up, transmitter 38 begins transmitting an encoded signal 42 containing predetermined information. Such predetermined information may include, for example, without limitation, geographical or level information regarding particulars of the location at which the sensor was initially placed prior to scouring. In a preferred embodiment, an RF transmitter capable of transmitting at a data rate of 10 Kbps (kilobits per second) at 433 MHz with a range of 3000 ft is employed. The transmissions with an anti-collision protocol made by a transmitter 38 are received by the receiver unit 18 which preferably has the ability to interpret and store the transmitted RF messages. As shown in FIG. 1, the receiver unit 18 may include a number of lights 44 or other suitable display that can provide an indication to an inspector or other personnel that one or more sensor units 16 have been activated and the identity and/or other particular information related to such activated units. Although not shown in the embodiment of FIG. 1, it is to be appreciated that the receiver unit 18 may include, or otherwise be connected to a further transmitting mechanism for providing an indication of activation of one or more sensor units 16 to a centralized location. Such further transmission may readily be accomplished through a direct wired communication (e.g., telephone) line or through one or more wireless (e.g., cellular) systems.

Accordingly, it is to be appreciated that the present invention provides a robust, cost-effective system and sensor that utilizes simple physical principles to detect scour and alert of its presence.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

Furthermore, it is to be appreciated that an important feature of the system for detecting scour described herein is the fact that the change in orientation (e.g., from vertical (or possibly) horizontal) of the sensor device is what triggers the automatic transmission of a wireless signal therefrom. In other words, an important feature of the invention is the ability of the sensor device to detect its orientation and to begin automatic transmission of a wireless signal when a particular change in orientation occurs and/or is detected. Such feature may additionally be employed in detection systems other than scour detection systems that involve structures that extends into a bed of material located under a body of water. For example, and without limitation, a sensor device as described herein wherein the change in orientation (e.g., from vertical (or possibly) horizontal) of the sensor device is what triggers the automatic transmission of a wireless signal therefrom may be used to detect the occurrence of mudslides or other movements of similar materials. More specifically, one or more sensor devices as described herein may be placed in the ground at certain locations in a first orientation (e.g., vertical). If a slide occurs where the ground materials move, the orientation of the associated sensor devices will change (e.g., to horizontal) and thereby trigger the automatic transmission of a wireless signal from the sensor device that identifies the sensor device. The wireless signal, once received by a receiver unit, may be used to identify the location of the sensor device (e.g., sensor device IDs may be mapped to specific locations in a database) and thus the location of the slide. In such a system, the receiver unit may be located in a remote location, and the sensor devices may be provided with long range wireless transmission capability (e.g., a cellular modem) so that the messages from the sensor devices can be transmitted over a longer distance to the receiver unit (e.g., the receiver unit may include a cellular receiver for receiving the signal). As another alternative, the sensor devices may be provided with a GPS receiver for determining the current location of the sensor devices, and that current location (and possibly a beginning/initial location of the sensor device) may be provided as part of the wireless signal/message that is automatically transmitted upon a change of orientation. The long range transmission and/or GPS alternatives just described may also be applied to the bridge scour embodiment and any other embodiment employing the concepts described herein.

As another example, a sensor device as described herein wherein the change in orientation (e.g., from vertical to horizontal) of the sensor device is what triggers the automatic transmission of a wireless signal therefrom may be used to detect flood conditions. More specifically, one or more sensor devices as described herein may be placed adjacent to and out of a body of water (e.g., along the banks of a river) at certain locations in a first orientation (e.g., vertical). If flooding occurs such that the water level increases (e.g., overflows onto the banks of the river or other body of water) and comes into contact with (i.e., knocks down) one or more of the sensor devices, the orientation of the associated sensor devices will change (e.g., to horizontal) and thereby trigger the automatic transmission of a wireless signal from the sensor device that identifies the sensor device. As described elsewhere herein, the sensor devices will be able to float in the water. The wireless signal, once received by a receiver unit, may be used to identify the location of the sensor device (e.g., sensor device IDs may be mapped to specific locations in a database) and thus the location of the flooding. In such a system, the receiver unit may be located in a remote location, and the sensor devices may be provided with long range wireless transmission capability (e.g., a cellular modem) so that the messages from the sensor devices can be transmitted over a longer distance to the receiver unit (e.g., the receiver unit may include a cellular receiver for receiving the signal). As another alternative, the sensor devices may be provided with a GPS receiver for determining the current location of the sensor devices, and that current location (and possibly a beginning/initial location of the sensor device) may be provided as part of the wireless signal/message that is automatically transmitted upon a change of orientation.

As still another example, a sensor device as described herein wherein the change in orientation (e.g., from vertical to horizontal) of the sensor device is what triggers the automatic transmission of a wireless signal therefrom may be used to detect the orientation of a person, and thus may be used to detect when, for example, an elderly person experiences a fall so that emergency personnel may be automatically altered to assist that person. In such an example, a long range wireless transmission may be employed, or, alternatively, a short range wireless transmission to a local receiver unit, which in turn automatically communicates with emergency personnel, may be employed.

What is claimed is:

1. A system for detecting scour associated with a structure having a part thereof extending into a bed of material located under a body of water, the system comprising:
a sensor unit buried in a portion of said bed of material located in proximity to said part, said sensor unit being structured to float to a surface of said body of water and automatically wirelessly transmit a message after being released from said bed of material in response to at least some of said portion of said bed of material being scoured; and
a receiver unit structured to wirelessly receive said message.

2. The system according to claim 1, wherein said sensor unit includes one or more switches structured to cause said sensor unit to automatically wirelessly transmit said message based on an orientation of said sensor unit.

3. The system according to claim 2,
wherein said sensor unit is in a first orientation when buried in a portion of said bed of material;
wherein, when in said first orientation, said one or more switches do not enable said sensor unit to automatically wirelessly transmit said message;
wherein said sensor unit is in a second orientation when floating on said surface of said body of water; and
wherein, when in said second orientation, said one or more switches cause said sensor unit to automatically wirelessly transmit said message.

4. The system according to claim 1, wherein said message identifies said sensor unit.

5. The system according to claim 1, further comprising a display device operatively coupled to said receiver unit and structured to generate a particular output based on said message.

6. The system according to claim 5, wherein said display device comprises a light indicator and wherein said particular output comprises a particular light output.

7. A system for detecting scour associated with a structure having a part thereof extending into a bed of material located under or partially under a body of water, comprising:
a plurality of sensor units, each of said sensor units being buried in an associated portion of said bed of material located in proximity to said part, each of said sensor units being structured to float to a surface of said body of water and automatically wirelessly transmit a message identifying the sensor unit after being released from said bed of material in response to at least some of said portion of said bed of material associated with the sensor unit being scoured; and
a receiver unit structured to wirelessly receive each said messages.

8. The system according to claim 7, wherein each associated portion of said bed of material is located at a different depth within said bed of material.

9. The system according to claim 7, wherein each associated portion of said bed of material is located at a different location within said bed of material.

10. The system according to claim 7, wherein each respective sensor unit of said plurality of sensor units includes one or more switches structured to cause the sensor unit to automatically wirelessly transmit said associated message based on an orientation of the sensor unit.

11. The system according to claim 10,
wherein each respective sensor unit of said plurality of sensor units is in a first orientation when buried in a portion of said bed of material;
wherein, when in said first orientation, said one or more switches do not enable said respective sensor unit to automatically wirelessly transmit said message;
wherein each respective sensor unit is in a second orientation when floating on said surface of said body of water; and
wherein, when in said second orientation, said one or more switches cause said respective sensor unit to automatically wirelessly transmit said message.

12. The system according to claim 7, further comprising a display device operatively coupled to said receiver unit and structured to generate a particular output based on each message that is received.

13. The system according to claim 12, wherein said display device comprises a light indicator and wherein said particular output comprises a particular light output.

14. A system for detecting an occurrence of an event, comprising:
a sensor unit provided at a particular three dimensional location, said sensor unit comprising one or more switches structured to cause said sensor unit to automatically wirelessly transmit a message based on an orientation of said sensor unit,
wherein said sensor unit is in a first orientation when provided at said particular location prior to the occurrence of the event, when in said first orientation said one or more switches do not enable said sensor unit to automatically wirelessly transmit said message, and
wherein said sensor unit is in a second orientation following the occurrence of the event, when in said second orientation said one or more switches cause said sensor unit to automatically wirelessly transmit said message; and
a receiver unit structured to wirelessly receive said message.

15. The system according to claim 14, wherein said event is a movement of material at said particular location, wherein said sensor unit is buried within the material in said first orientation prior to the occurrence of the event.

16. The system according to claim 14, wherein said event is flooding of a body of water at said particular location, wherein said sensor unit is provided adjacent to said body of water at said particular location in said first orientation prior to the occurrence of the event.

17. A sensor unit for detecting scour associated with a structure having a part thereof extending into a bed of material located under a body of water, the sensor unit comprising:
a housing structured to be buried in a portion of said bed of material located in proximity to said part, said housing being buoyant and structured to float to a surface of said body of water after being released from said bed of material in response to at least some of said portion of said bed of material being scoured; and
a system disposed in the housing, the system being structured to wirelessly transmit a message after the housing is released from said bed of material.

18. The sensor unit according to claim 17, wherein the system comprises:
a transmitter; and
one or more switches structured to cause said transmitter to automatically wirelessly transmit said message based on an orientation of said housing.

19. The sensor unit according to claim 18,
wherein said housing is in a first orientation when buried in a portion of said bed of material;
wherein, when in said first orientation, said one or more switches do not enable said sensor unit to automatically wirelessly transmit said message;
wherein said housing unit is in a second orientation when floating on said surface of or passing through said body of water; and
wherein, when in said second orientation, said one or more switches cause said sensor unit to automatically wirelessly transmit said message.

20. The sensor unit according to claim 17, wherein said message identifies said sensor unit.
